(19) United States
(12) Patent Application Publication
(10) Pub. No.: US 2002/0004903 A1
(43) Pub. Date: Jan. 10, 2002

(54) Controlled distributing of digital information, in particular audio

(76) Inventors: Franciscus Lucas Antonius Johannes Kamperman, Eindhoven (NL); Gerardus Cornelis Petrus Lokhoff, Eindhoven (NL)

Correspondence Address: U.S. Philips Corporation, 580 White Plains Road, Tarrytown, NY, 10591, US

(21) Appl. No.: 09/850,395

(22) Filed: May 7, 2001

(30) Foreign Application Priority Data
May 10, 2000 (EP) 00201663.2

(51) Int. Cl. H04L 9/32; G06F 12/14

(52) U.S. Cl. 713/182; 713/202; 705/51

(57) ABSTRACT

Distribution of digital information, in particular audio, is controlled as follows. An information carrier (11) like a CD is distributed which has at least part of the digital information encrypted using an encryption key. A decryption key corresponding to the encryption key is also distributed to the user, e.g. on a reserved area of the CD. The user (32) reproduces the audio on a player (31), which decrypts the information using the key. However, at least part of the information is only reproduced after a Personalized Access Code PAC (40) is received by the player. The PAC is generated at a remote access center (33), e.g. an internet site. A database (34) connected the center and a player memory hold a player identifier and secret player key. The user transmits the player identifier and an information identifier identifying the CD to the access center, and the access center calculates the PAC using the identifier and the secret player key. The PAC is transmitted to the player which verifies the PAC using its own secret player key, and enables the reproduction of PAC protected parts of the information.

The invention relates to a method for controlled distributing of digital information, in particular audio, in which the digital information is encrypted using an encryption key and transferred to a rendering device.

The invention further relates to a method for providing access codes.

The invention further relates to an information carrier comprising digital information, in particular audio, in encrypted form.

The invention further relates to an access signal.

The invention further relates to a rendering device.

The invention further relates to an access control software product.

A method for controlled distributing of digital information is known from WO 96/42154. Digital information, usually called content like audio/video, graphics or computer programs, is distributed in encrypted form via CD-ROM or via a server and a network to a user at the time the user requires the information, e.g. by buying the CD-ROM or downloading the information via the internet. Keys for decrypting the information are stored in a database in a central location, called an operations center. The user has to commnunicate with the center and may receive, after appropriate payment, the keys for decryption. The communication between the user and the center, which may be presumed not to be secure against eavesdroppers, has to be made secure by authentication and encryption techniques, in particular because the keys for decrypting the protected material have to be transmitted. However, such techniques are relatively complicated and require several messages to be exchanged between the user and the center. Such messages may require a substantial amount of bits to prevent attacks by brute force trial and error.

It is an object of the invention to provide means for controlled distribution of information which require less complicated communication and obviate the above problems.

For this purpose, in the method for controlled distributing of digital information as described in the opening paragraph, at least part of the digital information is encrypted using an encryption key and transferred to a rendering device, a decryption key corresponding to the encryption key is transferred to the rendering device for decrypting the digital information, the rendering device is provided with a public device identifier and a secret device identifier, which identifier and key are also stored in a remote database, the digital information is provided with an information identifier, the public device identifier and the information identifier are transferred to an access center, the remote database or the access center generates a personalized access code in dependence of the information identifier and the secret device identifier, the personalized access code is transferred to the rendering device, and the rendering device verifies the personalized access code using the secret device identifier and the information identifier and, in dependence thereon, makes the information available to the user. The effect is that access to the information can be controlled via the personalized access code, which is a simple code which can be manipulated by the human user. Only a simple message, comprising the information identifier and the device public identifier, needs to be sent to the center. The center needs to send only a single message back to the user, the personalized access code. It is to be noted, that the decryption keys do not have to be transmitted to the user via a potentially dangerous network, but may be transferred with the encrypted digital information or may be transferred via a separate channel, so that in the rendering device all key material for decrypting and accessing the content is already available. A rendering device which is compliant to the conditions for recovering the content, will use the personalized access code like a switch to enable said recovering. Further the access code is quite useless to a different (legal or illegal) user, because it is tuned to the rendering device of the legal user. Each user has to acquire his own personalized access code.

The invention is also based on the following recognition. The usual mechanisms for distributing information are not suitable for controlling the access to less valuable content, in particular in an environment where only limited communication to a central location is available. Therefore the inventors have seen, that distributing the decryption keys with the content, and in addition requiring a simple additional access code, improves the control the owner of the content has over the use of his content at the users location, without requiring several messages to be communicated to and from the central location. The personalized access code may have a limited length so that it can be easily communicated, remembered and typed on a keypad. In addition it is to be noted, that the content and decryption keys may be (freely) copied to a second user, but that the second user still needs the personalized access code for his (compliant) rendering device.

In a preferred embodiment of the method the digital information is provided with an address of the access center on the data network. This allows an easy communication of the user with the access center via the network.

In a further embodiment of the method the public device identifier and/or the personalized access code are non uniquely selected from a limited set of numbers. This allows short identifiers and codes, e.g. of 4 letters/digits, to be used, which can be easily handled by the used for typing in on a keyboard or transfer via a voice connection.

A second aspect of the invention lies in a method for providing personalized access codes, in which a public device identifier identifying a rendering device and an information identifier identifying digital information are received, a secret device identifier is recovered from a database based on the public device identifier, the personalized access code is generated in dependence of the information identifier and the secret device identifier, and the personalized access code is transferred to a rendering device.

In a further embodiment of the method the total number of personalized access codes is limited, or the personalized access codes are only provided within a predetermined period of time. This has the advantage that the distribution of the digital information can be controlled to specific user groups.

In a further embodiment of the method the secret device identifier is recovered from one of a multiple of databases, of which at least one is maintained by a manufacturer of rendering devices. This has the advantage that the distribution of the digital information can be controlled by said manufacturer.

A third aspect of the invention lies in an information carrier comprising digital information, in particular audio, in encrypted form, an decryption key for decrypting the digital information, an information identifier identifying digital information, and an access indicator for indicating a requirement for a personalized access code before allowing access to the digital information, the personalized access code being dependent on the information identifier and the rendering device. This has the advantage, that distribution of information in large amounts via a record carrier can be controlled via the access code.

A fourth aspect of the invention lies in an access signal comprising a personalized access code for enabling access to digital information, in particular audio, in encrypted form using an decryption key for decrypting the digital information in a rendering device, the personalized access code being dependent on an information identifier identifying digital information and the rendering device. The signal has the advantage that the personalized access code can be distributed via a transmission channel or a network.

A fifth aspect of the invention lies in a rendering device for rendering digital information, in particular audio, for a user, which device comprises means for receiving the digital information in encrypted form, a corresponding information identifier and a decryption key, means for decrypting the digital information using the decryption key, a memory comprising a public device identifier and a secret device identifier, control means for receiving a personalized access code and for verifying the personalized access code using the secret device identifier and the information identifier, and switching means for, in dependence on said verifying, enabling access of the user to the information. This has the advantage, that distributed digital information can be reproduced after receiving the access code giving the distributor additional options for controlling the use of his information.

In an embodiment of the rendering device the control means comprise a hash function based on a block cipher. This has the advantage, that the same block cipher can also be used for other cryptographic functions in the device, e.g. decryption of the main information.

A sixth aspect of the invention lies in an access control software product for enabling access to encrypted digital information on a rendering device, the software product having computer executable instructions for receiving a personalized access code, a secret device identifier and an information identifier verifying the personalized access code using the secret device identifier and the information identifier and, in dependence thereon, enabling access of the user to the information. This has the advantage, that the software including the device identifier and identifier may be used on a general purpose computer to allow access to the controlled distributed digital information.

Further advantageous, preferred embodiments according to the invention are given in the further dependent claims.

These and other aspects of the invention will be apparent from and elucidated further with reference to the embodiments described by way of example in the following description and with reference to the accompanying drawings, in which

FIG. 1 shows a record carrier (1a top view, 1b cross section),

FIG. 2 shows a reading device,

FIG. 3 shows providing a Personalized Access Code, and

FIG. 4 shows a one-way function.

### Corresponding elements in different Figures have identical reference numerals.

FIG. 1 a shows a disc-shaped record carrier 11 having a track 19 and a central hole 10. The track 19 is arranged in accordance with a spiral pattern of turns constituting substantially parallel tracks on an information layer. The record carrier is optically readable, called an optical disc, and is of read only type. The information is represented on the information layer by optically detectable marks along the track, e.g. indentations manufactured by pressing. The track comprises position information, e.g. addresses, for indication of the location of data blocks.

FIG. 1b is a cross-section taken along the line b-b of the record carrier 11, in which a transparent substrate 15 is provided with a reflecting layer 16 and a protective layer 17. The track 14 may be implemented as an indentation or an elevation, and marks are provided along the longitudinal direction of the track representing the information.

The record carrier 11 carries information represented by marks, which result in a modulated signal when optically detected. The modulated signal is subdivided in frames. A frame is a predefined amount of data corresponding to the data block preceded by a synchronizing signal. The data blocks comprise digital information, e.g. audio or video in a predefined format such as MP3 audio. Part of this digital information may be directly reproducible by a rendering device, e.g. an MP3 audio player. At least part of the information is encrypted using some encryption key, and a corresponding decryption key must be used for decrypting the information. The decryption key must be transferred to the rendering device, but should preferably be not readable by non-compliant devices, i.e. devices which do not obey the rules of the distributing system. For example standard PC CD-ROM drives should not be able to read the decryption key for data distributed according to the invention on a CD. In an embodiment the decryption key is stored in a reserved area 12 in the lead-in area, e.g. outside the area readable by a standard CD-ROM drive. In a different embodiment the decryption key is encoded in a parameter of the track, e.g. a modulation of the position of the track in a direction transverse to the longitudinal direction of the track, a so called wobble.

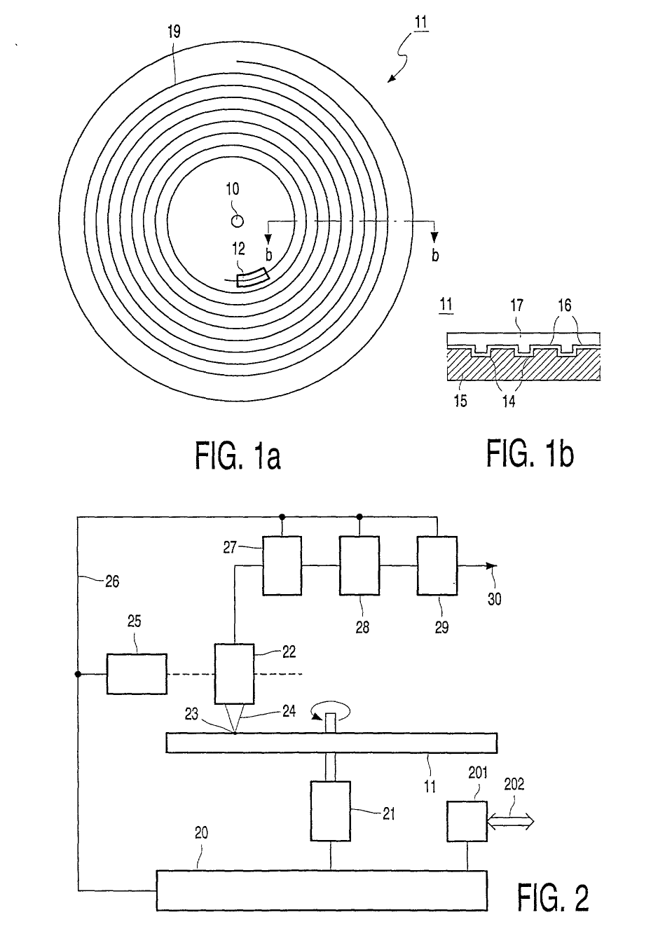

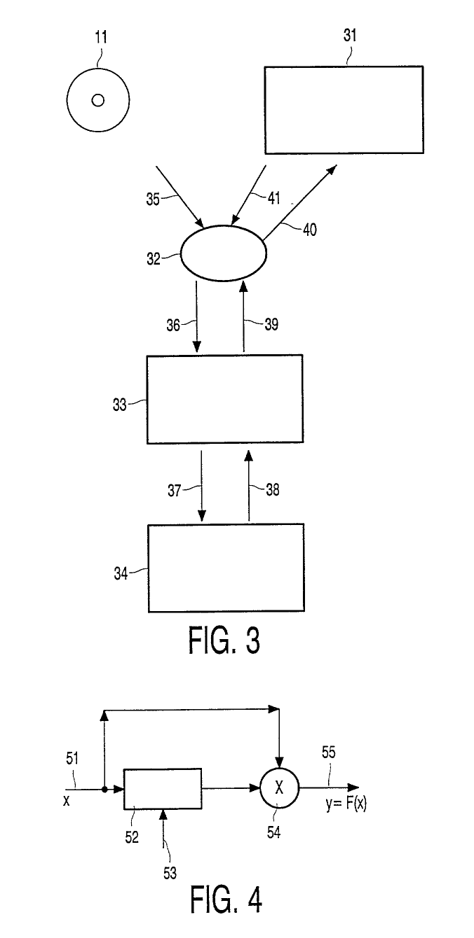

FIG. 2 shows a playback device for reading a record carrier 11, which record carrier is identical to the record carrier shown in FIG. 1. The device is provided with a drive unit 21 for rotating the record carrier 1, and a read head 22 for scanning the track 19 on the record carrier. The apparatus is provided with a positioning unit 25 for coarsely positioning the read head 22 on the track in the radial direction (perpendicular to the length direction of the track). The read head comprises an optical system of a known type for generating a radiation beam 24 guided through optical elements and focused to a radiation spot 23 on a track of the information layer of the record carrier. The radiation beam 24 is generated by a radiation source, e.g. a laser diode. The read head further comprises a focusing actuator for moving the focus of the radiation beam 24 along the optical axis of said beam and a tracking actuator for fine positioning of the spot 23 in a radial direction on the center of the track. The tracking actuator may comprise for example coils for radially moving an optical element or a piezo element for changing the angle of a reflecting element with respect to the optical axis of the beam 24. The radiation reflected by the information layer is detected by a detector of a usual type, e.g. a four-quadrant diode, in the read head 22 for generating a read signal and further detector signals including a tracking error and a focusing error signal, which are applied to said tracking and focusing actuators. The read signal is processed by a read unit 27 to retrieve the data, which read unit is of a usual type for example comprising a channel decoder. The data on the record carrier may be in encrypted form. The read head and read unit constitute means for receiving the digital information in encrypted form. The read data from the read unit is coupled to decryption unit 29 via switch unit 28. The decryption unit 29 has an output 30 for outputting decrypted data to the user or to a further reproduction unit, e.g. an audio or video decompression unit (not shown) included in the rendering device or located externally. The read device further comprises a control unit 20 for receiving commands from a user or from a host computer for controlling the apparatus via control lines 26, e.g. a system bus, and is connected to the drive unit 21, the positioning unit 25, the read unit 27, the switch unit 28 and the decryption unit 29. To this end, the control unit 20 comprises control circuitry, for example a microprocessor, a program memory and control gates, for performing the usual control procedures. The control unit 20 may also be implemented as a state machine in logic circuits. Further the control unit 20 comprises a memory holding a public device identifier Unique_Public_player_id UPPI and a corresponding secret device identifier Unique_Secret_Player_id USPI. The UPPI and USPI pair is uniquely coupled, and known only in the device and in a secure database, for example guarded by the manufacturer of the device. The operation of the device is described with reference to FIG. 3.

In an embodiment the player is provided with a communication unit 201 to communicate with the access center, e.g. a modem to the telephone network or an internet network connection indicated by arrow 202. The steps indicated below as performed by the user will now be performed via the communication unit 201.

FIG. 3 shows providing and use of a personalized access code. The user 32 is schematically indicated and performs the following steps. First (indicated by arrow 35) from the record carrier 11 an information identifier called Unique_Disc_id UDI and (indicated by arrow 41) the Unique_Public_player_id UPPI from the player 31 are derived, e.g. the UDI and UPPI may be readable with the human eye or a UDI code is read from the record carrier via the player 31. The UDI may also be the name of the group or artist and the title of the disc, which may be shown and selected on an internet web site. Secondly (indicated by arrow 36) the user contacts an access center 33, e.g. an internet site or a telephone call center, and transfers the UDI and UPPI. The address of the access center 33 may also be provided on the record carrier 11 or may be known from a different source (e.g. via the internet). Thirdly (indicated by arrow 37) the access center 33 communicates with a database unit 34 which holds the UPPI and corresponding the Unique_Secret_Player_id USPI. A calculation of function f is performed by the database unit 34 to calculate a Personal_Access_Code PAC: PAC=f(UDI, USPI). The PAC is communicated to the access center (indicated by arrow 38). The function f may be for example a keyed hash function, or any suitable cryptographic one-way function. Alternatively the USPI may be communicated to the access center 33 and the calculation of f may be performed there. Preferably the USPI is kept secret at all times by using cryptographic methods. Preferably the USPI is kept in a tamper resistant environment to prevent a hacker to read or change the USPI. Advantageously databases like unit 34 are kept by the several manufacturer of the different brands of players. In this way the manufacturers can be involved in the communication with the user, and may get revenues therefrom. The access center will communicate the PAC to the user (indicated by arrow 39). The access center may advantageously add additional information to this communication, such as further player control data or advertisements. Finally the use enters the PAC in the player (indicated by arrow 40), and the player now has all information required to reproduce the record carrier 11. Alternatively the player 31 may automatically communicate with the access center 33 to supply the UDI and USPI and acquire the PAC, and further display any additional information for the user on a build in display screen or on a connected monitor or TV set.

The player as shown in FIG. 2 is arranged to perform the following steps when a record carrier is to be reproduced. First the record carrier 11 is read to detect the UDI and/or the address of the access center, e.g. an URL (Universal Resource Location) on the internet. Such data are retrieved from the record carrier by control unit 20 via the read head 22 and the read unit 27. The UDI, URL and UPPI are communicated by control unit 20 to the access center via an interface, e.g. directly via a build in telephone modem or network access unit, or indirectly via the user 32 using a display and keyboard, which user may use a telephone or a separate computer with internet connection. The player receives the PAC via the same interface and calculates a verification function g(UID, USPI). The function g may be the same as function f above, and in that case must result also in the value PAC. Alternatively a function g₂(UID, USPI, PAC) may be used which results in a verifiable result. If the calculated value corresponds to the received value PAC the player enables the reproduction of the record carrier. The calculation and verification is performed in control unit 20, and control unit 20 operates switch unit 28 to block or pass the signal to decryption unit 29. The decryption unit 29 also receives a decryption key from the control unit 20. The decryption key may be read from a special area on the record carrier 11, e.g. a reserved area in the lead-in, or may be encoded in an additional parameter of the track, e.g. a disc wobble. Alternatively the decryption key may be retrieved from a different source, e.g. a user smart card or memory stick, or via a network like internet.

In an embodiment the PAC may be specific for a track on the information carrier by adding the track number to the functions f and g, e.g. PAC=f(UDI,USPI, TrackNumber).

In an embodiment of the player the control unit 20 comprises a memory for storing the UID and PAC for a number of record carriers. When a record carrier is to be reproduced, first the memory is checked to retrieve the PAC if already available. Now there is no need for the user to keep, memorize or get anew the PAC values.

In an embodiment the switch unit 28 is operated by the control unit 20 to remain blocked for a certain period if a wrong PAC value is received, or after a second or third wrong PAC value is received for the same UDI. A warning message may be issued first before the last try is accepted. Such extended blocking discourages any user to determine a PAC by trial and error.

In an embodiment of the method a length-limited UPPI may be used and selected from a limited set, e.g. from the 3 letter codes or 4 digit codes, to allow easy communication. Such limited code may be unique in combination with the brand and/or type of the player. In a further embodiment the limited UPPI may be substantially unique only, i.e. that some players may have the same UPPI because it is re-used after some time for a further newly manufactured player. If such players having the same UPPI are distributed geographically or in time, there is no practical disadvantage for the owner of the content to be protected (e.g. music), because users will in general still acquire their PAC via the network as intended. Preferably also the PAC has a limited length, for example the same length as the UPPI.

In an embodiment of the method the record carrier is provided with a secret disc identifier SDI coupled to the UDI. Alternatively (part of) the decryption key may be used. The UDI and SDI pair is also stored at the access center. In calculating the PAC the function f is extended to f=f(UDI, USPI, SDI). The player also reads the SDI from the record carrier for calculation a correspondingly extended function g. This has the advantage, that even if the USPI has become known to a malicious user, such user cannot calculate a PAC for the compromised compliant player, because the SDI cannot easily be read from the record carrier, e.g. on a non-compliant player in a standard PC.

An implementation of the functions f and g to be used in the method for generating the PAC and the verification in the player is a suitable cryptographic hash function, for example a one-way function y=x2 mod N with N a public modulus. Here N is the product of two secret large primes (N=p*q). Another possibility is the discrete-log one-way function conjectured by Diffie and Hellman (New Directions in Cryptography, IEEE Transactions on information theory, Vol IT-22, No. 6, November 1976, p.644-654): F(x)=αx in GF(p) with a a primitive element of GF(p). Here p is a large prime such that p−1 has a large prime factor. The above two implementations bear the disadvantage that the size of the arguments, i.e., the number of bits needed to be secure, is quite large. A practical system based on fewer bits can be to apply an appropriate secret-key encryption algorithm, e.g. the DES, with y=F(x)=x⊕DES(x). This is illustrated in the circuit of FIG. 4. Alternatively a specifically designed hash function may be used. Preferably the hash function is based on a block cipher (like DES in FIG. 4) which is also used for other cryptographic functions in the rendering device, like the decryption of the main information. Suitable examples of hash functions like SHA and MD5 can further be found in “Applied Cryptography, Second Edition: protocols, algorithms, and source code in C” of Bruce Schneier, 1996, ISBN 0-471-12845-7 John Wiley & Sons, Inc., chapter 18: One-Way Hash Functions.

FIG. 4 shows an implementation of a one-way function generator based on secret-key encryption algorithm. On the input 51 the bitpattern x (e.g. UDI) is applied and processed in the encryptor 52 by using a key from a key input 53 (e.g. USPI). The encryptor 52 may for example be a DES encryptor. The output of encryptor 52 is bitwise EXOR'd to the input x by logic EXOR unit 54, resulting in bitpattern y (e.g. PAC) on the output 55. The input of UDI may be stuffed to the appropriate length (a multiple of 8 bytes) for the blockwise operation of DES. Further (a part of) USPI may be concatenated to UDI.

Although the invention has been explained by embodiments using the CD or DVD-optical recording format, it may be applied for any format for storage of units of information. For example the record carrier may also be a magnetic type disc or a tape. It is noted, that the invention may be implemented by means of both hardware and software, and that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that ‘means’ may be represented by a single item or a plurality and that several ‘means’ may be represented by the same item of hardware. Further, the scope of the invention is not limited to the embodiments, and the invention lies in each and every novel feature or combination of features described above.

1. Method for controlled distributing of digital information, in particular audio, in which
at least part of the digital information is encrypted using an encryption key and transferred to a rendering device,
a decryption key corresponding to the encryption key is transferred to the rendering device for decrypting the digital information,
the rendering device is provided with a public device identifier and a secret device identifier, which identifier and key are also stored in a remote database,
the digital information is provided with an information identifier,
the public device identifier and the information identifier are transferred to an access center,
the remote database or the access center generates a personalized access code in dependence of the information identifier and the secret device identifier,
the personalized access code is transferred to the rendering device, and
the rendering device verifies the personalized access code using the secret device identifier and the information identifier and, in dependence thereon, makes the information available to the user.

2. Method as claimed in claim 1, wherein the public device identifier, the information identifier, and the personalized access code are transferred via a data network.

3. Method as claimed in claim 2, wherein the digital information is provided with an address of the access center on the data network.

4. Method as claimed in claim 1, wherein the public device identifier and/or the personalized access code are non uniquely selected from a limited set of numbers.

5. Method for providing personalized access codes for use in the method of claim 1, in which
a public device identifier identifying a rendering device and an information identifier identifying digital information are received,
a secret device identifier is recovered from a database based on the public device identifier,
the personalized access code is generated in dependence of the information identifier and the secret device identifier,
the personalized access code is transferred to a rendering device.

6. Method as claimed in claim 5, wherein the total number of personalized access codes is limited, or the personalized access codes are only provided within a predetermined period of time.

7. Method as claimed in claim 5, wherein the secret device identifier is recovered from one of a multiple of databases, of which at least one is maintained by a manufacturer of rendering devices.

8. Information carrier for use in the method of claim 1, comprising digital information, in particular audio, in encrypted form, an decryption key for decrypting the digital information, an information identifier identifying digital information, and an access indicator for indicating a requirement for a personalized access code before allowing access to the digital information, the personalized access code being dependent on the information identifier and the rendering device.

9. Information carrier as claimed in claim 8, wherein the access indicator is arranged for indicating said requirement only for selected parts of the digital information.

10. Information carrier as claimed in claim 8 or 9, wherein the information is represented by optically readable marks in a track.

11. Information carrier as claimed in claim 10, wherein the decryption key is represented in a parameter of the track different from the optically readable marks, in particular in a track wobble.

12. Access signal for use in the method of claim 1, comprising a personalized access code for enabling access to digital information, in particular audio, in encrypted form using a decryption key for decrypting the digital information in a rendering device, the personalized access code being dependent on an information identifier identifying digital information and the rendering device.

13. Rendering device for use in the method of claim 1, for rendering digital information, in particular audio, for a user, which device comprises
means for receiving the digital information in encrypted form, a corresponding information identifier and a decryption key,
means for decrypting the digital information using the decryption key,
a memory comprising a public device identifier and a secret device identifier,
control means for receiving a personalized access code and for verifying the personalized access code using the secret device identifier and the information identifier, and
switching means for, in dependence on said verifying, enabling access of the user to the information.

14. Rendering device as claimed in claim 13, wherein the control means comprise a hash function based on a block cipher.

15. Rendering device as claimed in claim 13, the device comprising an access code memory for storing at least one information identifier and the corresponding personalized access code, the verification means being arranged for reading the personalized access code from the access code memory for enabling the access to information of which the information identifier is present in the memory.

16. Access control software product for use in the method as claimed in claim 1, for enabling access to encrypted digital information on a rendering device, the software product having computer executable instructions for
receiving a personalized access code, a secret device identifier and an information identifier
verifying the personalized access code using the secret device identifier and the information identifier and, in dependence thereon, enabling access of the user to the information.

17. Access control software product as claimed in claim 16, wherein the software includes a public device identifier and a secret device identifier.

18. Record carrier comprising the access control software product as claimed in claims 16 or 17.
